(19) United States
(12) Patent Application Publication
(10) Pub. No.: US 2007/0049484 A1
(43) Pub. Date: Mar. 1, 2007

(54) Nanocomposite ceramics and process for making the same

(76) Inventors: Bernard H. Kear, Whitehouse Station, NJ (US); William E. Mayo, Allentown, NJ (US); W. Roger Cannon, East Brunswick, NJ (US)

Correspondence Address: Kenneth Watov;WATOV & KIPNES, P.C., P.O. Box 247, Princeton Junction, NJ, 08550, US

(21) Appl. No.: 11/360,229

(22) Filed: Feb. 23, 2006

Related U.S. Application Data
(60) Provisional application No. 60/655,748, filed on Feb. 24, 2005.

(51) Int. Cl. C04B 35/488

(52) U.S. Cl. 501/103; 501/104

(57) ABSTRACT

A nanocomposite ceramic composition and method for making the same, the composition comprising a uniform dispersion of nanosize ceramic particles composed of at least one ceramic phase, interspersed and bound throughout a tough zirconia matrix phase.

### RELATED PATENT AND APPLICATION

This application claims priority to co-pending U.S. Provisional Patent Application No. 60/655,748, which was filed on Feb. 24, 2005. The present Application is also related to U.S. Pat. No. 6,395,214, entitled “High Pressure And Low Temperature Sintering Of Nanophase Ceramic Powders”, issued on May 28, 2002, the teachings of which are incorporated herein by reference to the extent they do not conflict herewith.

### GOVERNMENT INTEREST

The U.S. Government has a paid-up license in this invention and the right in limited circumstances to require the patent owner to license others on reasonable terms as provided for by the terms of Grant Number N00014-01-1-0079, awarded by the Office of Navel Research.

### FIELD OF THE INVENTION

The present invention relates generally to nanocomposite ceramic materials, and more particularly to nanocomposite ceramic materials containing at least one dispersed ceramic phase and a zirconia-containing matrix phase.

### BACKGROUND OF THE INVENTION

Over a decade of research has been invested into studying the promise of nanostructured ceramic or nanocomposite ceramic (NCC) materials. It has been found that reducing the grain size of single or multi-phase ceramics down to nanoscale dimensions significantly enhances the physical properties of ceramic materials in general. Experimental data has shown significant improvements in physical properties of nanoceramic composites as compared to microceramic composites as recorded, for example, in Table 1 below.

TABLE 1
Experimental Verification of Property
Enhancements in Nanocomposite Ceramics

| | Percent Improvement | |
|---|---|---|
| | (nano grain over micro | |
| Physical Property | grain counterparts) | Material System |
| Fracture Strength | 60%-200% | Y₂O₃ stabilized |
| | | ZrO₂ Al₂O₃/YAG |
| Toughness | 30%-100% | Al₂O₃/ZrO₂ |
| | | Al₂O₃/SiC |
| Wear Resistance | 30%-2500% | Si₃N₄ |
| | | Al₂O₃ |
| | | Al₂O₃/TiO₂ |
| Lubricity | 100-500% | ZnO |
| | | Al₂O₃/TiO₂ |
| Scratch Resistance | 80% | TiO₂/Epoxy |
| Thermal Shock Resistance | 70% | LiAlSiO₄ |

However, such significant property improvements in nanoceramic composites have only been observed experimentally. Commercial realization of such improvements has met with limited success. Conventional sintering methods for converting nanoceramic powders into nanoceramic composites have a tendency to generate “explosive” grain growth due to the presence of a high driving force resulting from the inherent large surface area of the starting materials. The high surface to volume ratio found in nanoscale materials known to enhance the material's physical properties can also promote nanoscale grain growth during sintering. Thus, the promise of nanoscale materials would not be realized unless the grain growth problem during sintering can be resolved or mitigated.

One process or method utilizing field-assisted sintering has demonstrated retention of nanoscale grain sizes in sintered composites. Nanophase Al₂O₃-base composites with a dispersed phase selected from diamond, SiC or Nb have shown substantial improvements in hardness and toughness. For example, Al₂O₃/10 vol. % diamond with grain size of about 100 nm showed higher hardness (25 GPa) and enhanced toughness (3.5 MPa✓m) than conventional coarse-grained Al₂O₃. Another nanocomposite material comprising Al₂O₃/10 vol. % Nb exhibited much improved toughness of at least 8 MPa✓m, and a high hardness of from about 20 to 23 GPa. In a test performed on “nano/micro” composites comprising micro-Al₂O₃/5 vol. % nanoSiC, improvements in fracture strength of from about 320 MPa to 1050 MPa, and in K_{IC} of from about 3.2 MPa✓m to 4.7 MPa✓m than conventional micro-Al₂O₃ have been reported. In the same material, a three orders of magnitude improvement in high temperature creep strength, about a 25% improvement in high temperature toughness at low loading rates, and two orders of magnitude improvement in high-load wear rate of Al₂O₃ was observed with the addition of nanoscale SiC particles.

It would be an advance in the art of nanocomposite ceramics to produce a new class of ZrO₂-base nanocomposite ceramics (NCCs) as hard and tough materials for structural applications. The novel ZrO₂-base NCC material is composed of two or more phases, in which the matrix or binder phase is tough partially-stabilized ZrO₂ (PSZ) and the particle dispersed phase includes one or more hard ceramics, such as, for example, α-Al₂O₃. The partially stabilized zirconia phase may contain additives including, but not limited to Y₂O₃, CaO, MgO, or CeO or similar compounds as stabilizing additives. It would be desirable to provide an effective means for controlling grain size, distribution, morphology, contiguity and volume fraction of the constituent phases in NCC materials whereby the resulting materials are produced with custom tailored physical properties to match the performance requirements of specific applications.

It would be further desirable to produce ZrO₂-base NCC materials that can readily be used in turbochargers, valves and other engine parts, machine tools and drill bits, razor blades, surgical scalpels and household knives. There is a further need for a process of fabricating such nanocomposite ceramic materials using existing reagents and equipment commercially available and which can be performed in an environmentally compatible, cost efficient and simple manner.

### SUMMARY OF THE INVENTION

The present invention is directed generally to nanocomposite ceramic materials and processes for making the same. The nanocomposite ceramic materials of the present invention are selected from a class of ZrO₂-base nanocomposite ceramics. In the present invention, the novel class of ZrO₂-base nanocomposite ceramics (NCC) maintains both high hardness and good fracture toughness.

In particular, the present invention is directed to two forms of ZrO₂-base nanocomposite ceramics: a two-phase NCC structure composed of a uniform dispersion of hard ceramic particles in the form of a ceramic phase such as, for example, Al₂O₃, MgAl₂O₄ or ZrSiO₄ interspersed in a matrix or binder phase such as, for example, partially stabilized zirconia (PSZ), and a multi-phase NCC structure composed of a uniform dispersion of two or more hard ceramic particles in the form of a ceramic phase interspersed in a tough PSZ matrix phase. The NCC materials of the present invention exhibit enhanced hardness while maintaining good toughness. Although the present invention is generally described as having a zirconia-based matrix phase, the present invention is not limited to such and further encompasses a two-phase NCC structure having a matrix phase composed of any ceramic material, in addition to PSZ, including, but not limited to Al₂O₃, MgAl₂O₄ and ZrSiO₄.

Depending on the application, the desired hardness can be adjusted by varying the volume fraction of the dispersed ceramic phase in the matrix phase without appreciably reducing the toughness. In this manner, the physical and mechanical properties of the particle-dispersed NCC materials can be tailored to the performance requirements of specific applications.

The methods of the present invention can be used to fabricate the novel nanocomposite ceramics. The present method generally includes rapidly solidifying molten particles to form nanosize metastable powder particles, and pressure sintering the metastable powder particles to mitigate grain growth during sintering to obtain a nanocomposite ceramic material. A novel approach in the present invention involves the use of superplasticity to achieve rapid densification, while minimizing growth of the constituent nanophases. The superplasticity is typically encountered during pressure-assisted sintering at high temperature. This approach can be most effectively achieved by minimizing the exposure time at about the peak sintering temperature. The use of such high temperature superplasticity-enhanced sintering is preferred, since it reduces cycle time and production costs to obtain a desirable nanocomposite structure.

The processes of the present invention have been found to afford considerable flexibility in tailoring the properties of the resulting nanocomposite ceramic materials to meet the performance requirements of a range of applications. Furthermore, the novel class of hard and tough ZrO₂-based nanocomposite ceramics can be employed in a range of potential applications including, but not limited to, turbochargers, valves, engine parts, machine tools, drill bits, razor blades, surgical scalpels, household knives and the like. The different forms and shapes of products fashioned out of the present invention can be fabricated through conventional powder processing methods such as, for example, tape casting for forming thin sheets, slip casting for forming hollow parts, die pressing or injection molding for forming solid parts, and others.

In one aspect of the present invention, there is provided a nanocomposite ceramic composition, comprising a composite formed from a metastable starting material that decomposes in a sequence of one or more steps to form a uniform dispersion of hard ceramic particles composed of at least one ceramic phase, interspersed and bound throughout with a ceramic matrix phase. In one embodiment of the present invention, the ceramic matrix phase is composed of zirconia, preferably partially stabilized zirconia.

In another aspect of the present invention, there is provided a method of making a nanocomposite ceramic composition, comprising the steps of:

rapidly solidifying molten particles of at least one ceramic phase and a ceramic matrix phase to yield metastable particles; and

consolidating the metastable particles to yield a uniform dispersion of nanosize particles of at least one ceramic phase interspersed and bound throughout with a metastable ceramic matrix phase. In one embodiment of the present invention, the ceramic matrix phase is composed of zirconia, preferably partially stabilized zirconia.

### BRIEF DESCRIPTION OF THE DRAWINGS

Various embodiments of the invention are described in detail below with reference to the drawings, in which like items are identified by the same reference designations, wherein:

FIG. 1 is a micrograph of a uniform 50 nm grain structure in fully sintered α-Al₂O₃ produced by pressure assisted sintering;

FIGS. 2A through 2D represent schematic diagrams of various methods for enhancing fracture strength and toughness to ceramics including crack deflection, and crack bridging; (These Figures were derived from M. W. Barsoum, Fundamentals of Ceramics, McGraw Hill, 1997, p. 418-423.)

FIGS. 3A through 3B represent schematic diagrams of another method for enhancing fracture strength and toughness of ceramics through transformation toughening;

FIG. 4 is a graph illustrating a phase diagram for a ZrO₂—Al₂O₃ system for two compositions YZ20A and YZ57A, wherein YZ is a partially stabilized ZrO₂ (3 mol % Y₂O₃) and A is Al₂O₃;

FIG. 5A is a micrograph of water quenched particles having highly segregated cellular structures composed of a metastable highly supersaturated t-ZrO₂ phase;

FIGS. 5B and 5C are micrographs of a uniform nanocomposite structure comprising about 28 vol % α-Al₂O₃ particles dispersed in a t-ZrO₂ matrix phase;

FIG. 6 shows X-ray diffraction patterns of YZ-20A powder before and after splat quenching;

FIGS. 7A and 7B are micrographs showing microstructures of water quenched YZ-57A, comprising a rod-like t-ZrO₂ and an α-Al₂O₃ matrix phase at about 100 nm diameters;

FIG. 8 shows X-ray diffraction patterns of YZ-57A powder before and after melt quenching;

FIGS. 9A through 9C are micrographs showing microstructures of YZ-57A powder at various stages of annealing;

FIG. 10A through 10C are SEM micrographs showing microstructures of YZ27A22S powder after heat treatment at various temperatures, 1200° C., 1400° C., and 1600° C., respectively;

FIGS. 11A and 11B are SEM micrographs showing the fracture structure of a fully dense triphasic material after sintering at a temperature of about 1600° C. for 2 hours;

FIG. 12 is a schematic diagram of a melt-quenching apparatus showing the trajectories of feed particles;

FIGS. 13A, 13B, and 13C illustrate composition representations of a yttria-stabilized zirconia (YSZ) matrix phase at various vol % of Al₂O₃ of 20 vol % Al₂O₃ (particle dispersed NCC), 50 vol % Al₂O₃ (bi-continuous NCC), and 80 vol % Al₂O₃ (particle dispersed NCC), respectively, for increasing hardness and decreasing toughness, respectively; and

FIGS. 14A and 14B illustrate composition representations of a uniformly fine distribution of hard ceramic particles in a tough YSZ matrix phase, respectively.

### DETAILED DESCRIPTION OF THE INVENTION

The nanocomposite ceramic of the present invention is generally composed of a uniform dispersion of ceramic nanoparticles such as, for example, α-Al₂O₃ in a nanocrystalline matrix phase at least substantially composed of zirconia such as, for example, partially-stabilized t-ZrO₂ (PSZ). The nanodispersed α-Al₂O₃ ceramic phase imparts to the resulting nanocomposite hardness, stiffness and strength, whereas the nanocrystalline PSZ matrix phase imparts to the resulting nanocomposite fracture strength and toughness. Although the present invention is generally described as having a zirconia-based matrix phase, the present invention is not limited to such and further encompasses a two-phase NCC structure having a matrix phase composed of any ceramic material, in addition to PSZ, including, but not limited to Al₂O₃, MgAl₂O₄ and ZrSiO₄.

Two processing methods have been developed to resolve the problem of grain growth during sintering. One method is used for processing single phase, nanocrystalline ceramics, and the other method is used for processing multiphase, nanocomposite ceramics.

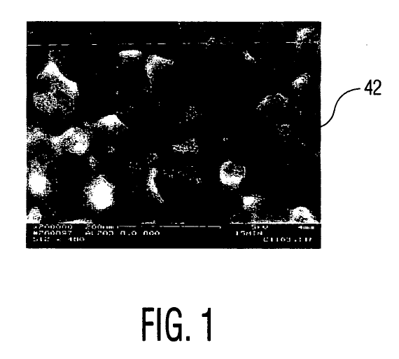

The first method involves the use of metastable nanoscale particles as the starting material, and pressure assisted sintering to yield a nanocrystalline ceramic product comprising nanoscale grain sizes. This preservation of nanograin size is possible because, during compaction and sintering, a metastable-to-stable phase transformation occurs resulting in increased density, enhanced sintering kinetics, and minimal grain growth. Control of grain growth is achieved by keeping the sintering temperature low, thus minimizing diffusion, while maintaining the high pressure to maximize nucleation. The method has been applied to single-component nanosize ceramic powders such as nanoTiO₂ and nanoAl₂O₃, typically produced by rapid condensation from a supersaturated vapor state. The net result of the consolidation process is the production of nanocrystalline ceramics with relative densities of at least 99% and with grain sizes at least smaller than the initial powder particle size. For the purpose of this description of this invention, nanoscale grain size shall be defined as less than 500 nanometers (nm). An example of a uniform 50 nm grain structure 42 of a fully sintered α-Al₂O₃ is shown in FIG. 1 wherein the starting powder was metastable γ-Al₂O₃ exhibiting a particle size of about 30 nm.

The second method involves the use of metastable microscale particles as the starting material, and pressure assisted sintering to yield a nanocomposite ceramic product. The metastable powder particles can generally be produced by plasma spraying of a conventional aggregated feed powder, which is followed by rapid quenching of the molten particles in cold water or other suitable quenching media. Depending on cooling rate and composition, the rapidly quenched powder may be in the form of an extended solid solution phase, a metastable intermediate phase or an amorphous phase. After controlled decomposition of the metastable powder during pressure-assisted sintering, the final structure consists of a nanoscale mixture of the two or more phases predicted by the equilibrium phase diagram, i.e. a nanocomposite ceramic (NCC) structure. In the systems that have been studied to date, Al₂O₃/13TiO₂ and ZrO₂(3Y₂O₃)/20-57Al₂O₃, the equilibrium two-phase NCC structures are α-Al₂O₃+rutile-TiO₂ and t-ZrO_{2 l +α-Al}₂O₃, respectively.

It is noted that lower sintering pressures are required for producing a nanocomposite ceramic (NCC) than a nanocrystalline ceramic (NC). There is strong impedance to grain coarsening in the co-nucleation of two or more nanophases during pressure assisted sintering. The pressure requirements for producing NCC extend up to 1.5 GPa, which is well within the capability of currently available hot pressing technologies.

The present invention is further directed to enhancing the fracture strength and toughness of ceramics in the form of nanocomposites. The three most familiar toughening mechanisms are known as crack deflection, crack bridging, and transformation toughening.

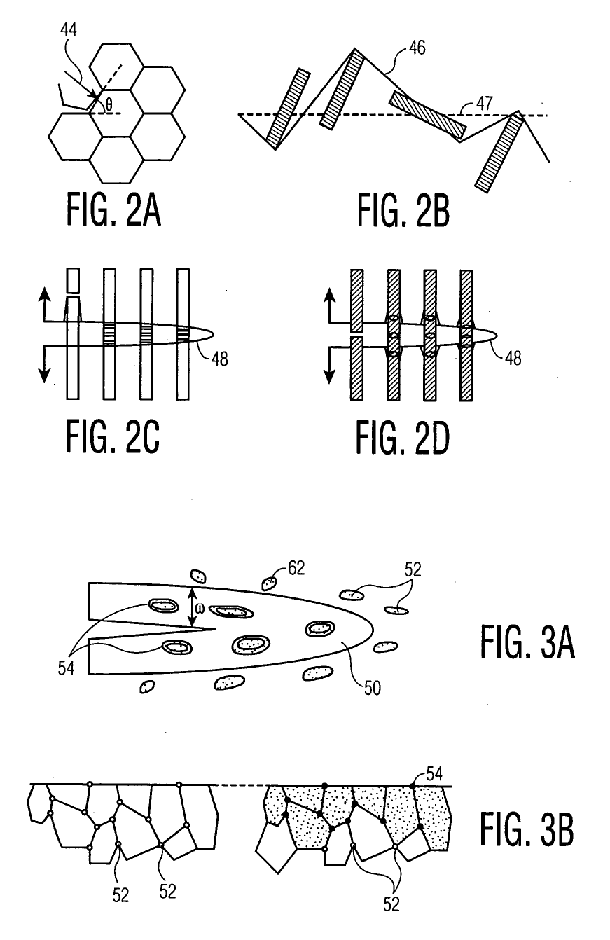

Polycrystalline ceramics generally exhibit enhanced fracture toughness as compared to monocrystalline ceramics. This characteristic is typically attributed to crack deflection 44 along weak grain boundaries as shown in FIG. 2A, which operates to reduce the effective stress intensity at the crack tip. The effect is small, e.g. the fracture toughness of polycrystalline Al₂O₃ is about twice that of single crystal Al₂O₃. On the other hand, crack deflection 46 around an elongated reinforcing phase 47, as shown in FIG. 2B is a particularly effective toughening mechanism. Finer grain size can also improve fracture strength, apparently because the intrinsic flaw size scales with the grain size.

In fiber-reinforced ceramics, bridging of the crack surfaces behind the crack tip 48 is a potent toughening mechanism, as shown in FIG. 2C, particularly when partial fiber-matrix debonding occurs, as shown in FIG. 2D. The increased toughness arises because the stretched fibers exert closure forces on the crack surfaces and reduce the average stress intensity at the crack tip 48. The fracture strength increases with volume fraction of fiber-reinforcing phase and with weak fiber/matrix interfaces.

Transformation toughening is generally applicable in ceramics including ZrO₂-base ceramics that are susceptible to a stress-induced phase transformation of original metastable tetragonal zirconia particle 52 to martensitically transformed zirconial particle 54 (tetragonal to monoclinic) in the vicinity of a crack tip 50, as shown in FIG. 3A. Since the phase transformation is accompanied by a volume expansion of about 4%, the effect is to place the region ahead of the crack tip in compression, which enhances both strength and toughness by inhibiting crack propagation. Surface compressive stresses can also be generated by abrading the material to induce this favorable phase transformation, as shown in FIG. 3B. In this manner, the fracture strength is increased by a factor of two.

Zirconia (ZrO₂) based ceramics are classified into three major groups. One group includes partially stabilized zirconia (PSZ). In this form, the cubic phase is partially stabilized by an addition of Y₂O₃, MgO or CaO. Upon heat treatment, the cubic phase undergoes partial decomposition to form coherent tetragonal precipitates, which are small enough to transform just ahead of a crack tip, similarly to that shown in FIG. 3A. The second group includes tetragonal zirconia polycrystal (TZP). These ceramics are composed entirely of tetragonal ZrO₂, with additions of small amounts of Y₂O₃ and other rare-earth oxides. They are exceptionally strong materials with bend strengths that exceed 2000 MPa. The third group includes zirconia-toughened ceramic (ZTC). These are dispersion-strengthened ceramics, in which fine particles of tetragonal ZrO₂ are dispersed in an alumina, mullite or spinel matrix.

Applicants note that the toughening mechanisms operative in the ZrO₂-based nanocomposite ceramics of the present invention are not yet fully understood, but it seems clear that transformation toughening is an important, and potentially a critical factor in producing materials with hardness and toughness. Another contributing factor, not previously considered, is believed to be the thermal expansion mismatch between the ceramic phase (e.g., α-Al₂O₃) and the ZrO₂-based matrix phase (e.g., PSZ), which upon cooling from the pressure-assisted sintering temperature generates compressive stresses in the ceramic particles (e.g., α-Al₂O₃ particles). The presence of such pre-stressed ceramic particles (e.g., α-Al₂O₃ particles) may influence crack propagation characteristics of the material. Applicants predict that crack advancement is impeded by the presence of such compressively-stressed ceramic particles (e.g., α-Al₂O₃ particles), in a similar manner as dislocation motion is impeded by the presence of fine particles of a hard second phase.

Correspondingly, when the propagation of the crack is temporarily arrested by these obstacles, then a stress-induced phase transformation (tetragonal to monoclinic) in the PSZ matrix may occur, thus further impeding crack growth. Accordingly, under an increasing stress, the developing crack tends to advance in a stop-start fashion. When the stress at the crack tip is sufficiently high, then the crack should be able to circumvent these obstacles by a crack deflection mechanism, probably along weak interfaces between the ceramic phase (e.g., α-Al₂O₃) and the matrix phase (e.g, t-ZrO₂). Even so, this behavior will have to be repeated many times during crack advancement, so that the overall effect is to enhance the fracture strength and toughness of the present nanocomposite ceramic.

Another factor that is currently being examined is the influence of grain morphology on the fracture behavior of the nanocomposite ceramic of the present invention. This is of interest because of the well-known advantages of altering the morphology of some fraction of the grains in sintered Si₃N₄. It has been observed that when some of the grains are elongated (i.e. have high aspect ratios), the fracture strength of the material is enhanced, apparently by a crack deflection mechanism (see FIG. 2B). In current research, the effect of stress-annealing is being examined as a means to modify the morphologies of the constituent phases in the nanocomposite material, particularly that of the dispersed or ceramic phase (e.g., α-Al₂O₃).

Table 2 below lists individual physical properties of alumina and partially-stabilized zirconia.

TABLE 2
Properties of Alumina (Al₂O₃) and Partially-Stabilized
Zirconia (PSZ).

| | Young's modulus | K Ic | Vickers hardness |
|---|---|---|---|
| | (GPa) | (Mpa · m^{1/2}) | (GPa) |
| Al₂O₃ | 390 | 2.0-6.0 | 19.0-26.0 |
| PSZ | 190 | 3.0-15.0 | 13.0 |
| | Density | Thermal expn. | Thermal cond. |
| | (g/cm³) | (° C.⁻¹) × 10⁶ | (W/m · K) |
| Al₂O₃ | 3.98 | 7.2-8.8 | 30.0-35.0 |
| PSZ | 6.10 | 12 | 2.0 |

The hardness and toughness of the nanocomposite ceramic of the present invention can be predictably adjusted by varying the volume fractions of the corresponding ceramic and matrix phases. For example, by increasing the volume fraction of the ceramic phase such as α-Al₂O₃ particles, the hardness of the nanocomposite ceramic is enhanced while slightly reducing fracture toughness, and vice versa.

In one embodiment of the present invention, the process of making the present nanocomposite ceramic involves the use of superplasticity, which accompanies phase decomposition during pressure-assisted sintering at relatively high temperatures, to achieve rapid densification without causing significant growth of the constituent nanophases. This can be done most effectively by minimizing the exposure time at the peak sintering temperature.

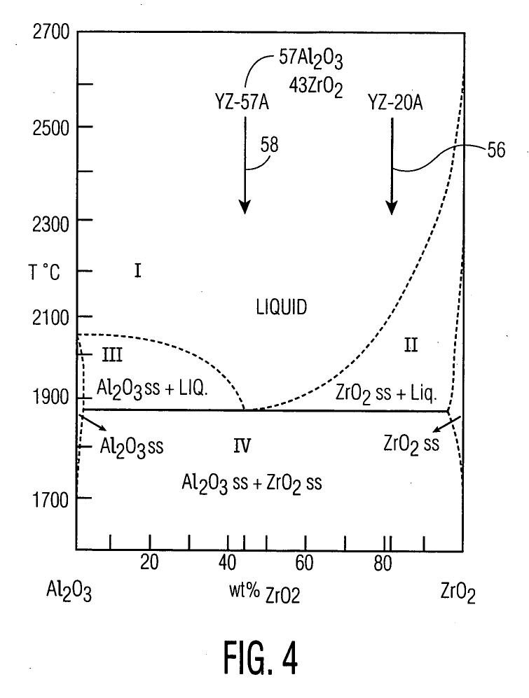

Referring to FIG. 4, a phase diagram for a composition comprising ZrO₂—Al₂O₃ system is shown. The compositions shown are YZ20A represented by line 56, and YZ57A represented by line 58, where YZ is partially stabilized ZrO₂ (3 mol % Y₂O₃), and A is Al₂O₃. The ZrO₂ content of YZ57A is about 43% by weight, and of YZ20A is about 81% by weight. Compositions in Region I are indicated as liquid in phase. Compositions in Regions II and IlIl are indicated as a combination of liquid and solid phases. Compositions in Region IV are indicated as solid in phase. As will be shown below, rapid solidification of the two compositions generates metastable structures, which upon subsequent pressure-assisted sintering yield nanocomposite structures: biphasic nanocomposites (t-ZrO₂+α-Al₂O₃) for the two compositions. YZ-57A transforms from a liquid in Region I directly into a solid in Region I during rapid cooling as indicated by line 58, while YZ-20A transforms into a combination of liquid and solid phases as it cools from a liquid phase to a solid phase as indicated by line 56.

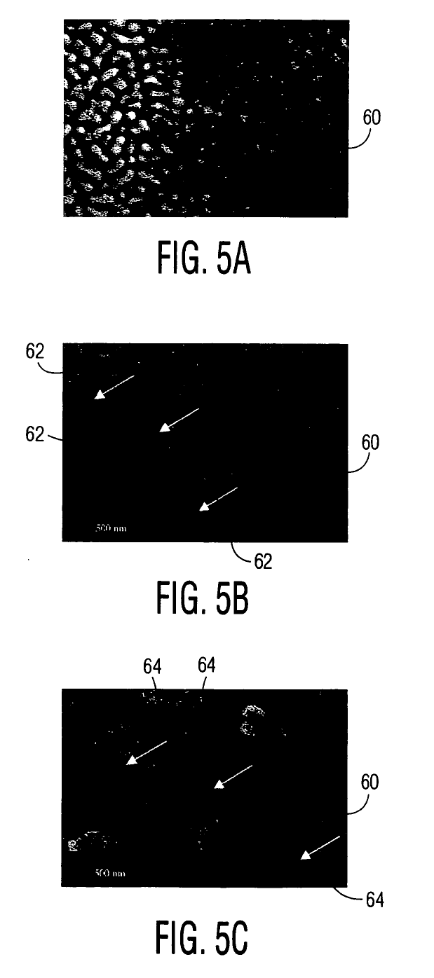

Referring to FIGS. 5A to 5C, microstructures 60 of YZ-20A (ZrO₂(3Y₂O₃)/20Al₂O₃) powder are shown at various stages of processing. Referring to FIG. 5A, the particles after water quenching, exhibit segregated cellular structures comprising substantially of metastable, highly supersaturated t-ZrO₂ phase. Smaller particles are cooled at higher rates, and thus exhibit more refined cellular structures. Referring to FIG. 5B, a ceramic composition YZ-20A annealed at about 1200° C. for about an hour exhibits the appearance of fine-scale Al₂O₃ particles 62 in the cellular interstices. Referring to FIG. 5C, a ceramic composition YZ-20A annealed at about 1400° C. for about an hour, exhibits coarsening of the uniformly dispersed Al₂O₃ particles 64.

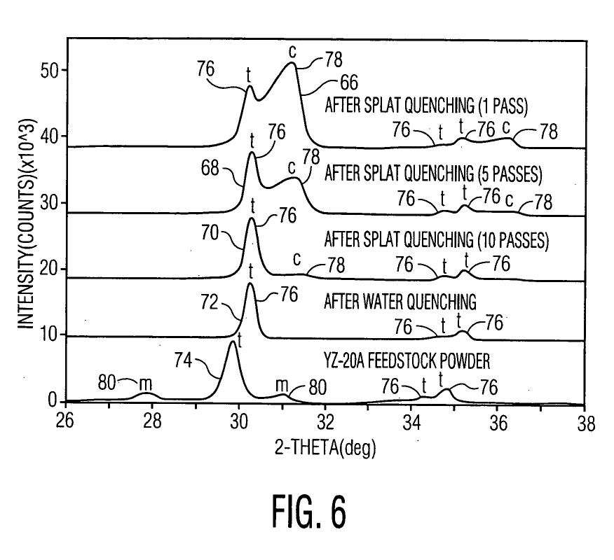

The corresponding splat-quenched material of FIGS. 5A-5C, exhibited homogeneous structures and contained some retained cubic-ZrO₂ due to the very rapid quenching. Referring to FIG. 6, a series of x-ray diffraction patterns 66, 68, 70, 72 and 74, respectively, are shown for YZ-20A powder before and after splat quenching. The pattern 66 represents structures after one pass of splat quenching. The pattern 68 represents structures after five passes of splat quenching. The pattern 70 represents structures after ten passes of splat quenching. The pattern 72 represents structures after water quenching. The pattern 72 represents structures of the YZ-20A feedstock powder.

Peaks 76 indicate the presence of tetragonal ZrO₂, peaks 78 indicate the presence of cubic ZrO₂ and peaks 80 indicate the presence of monoclinic ZrO₂. The amount of cubic phase as indicated by peaks 78 was significant in the first splat-quenched layer represented by pattern 66, but decreased with increasing number of layers represented by patterns 68, 70, 72 and 74, respectively, as shown in FIG. 6. This was taken to be evidence for a progressive reduction in heat transfer with increasing deposit thickness, due to the low thermal conductivity of the ZrO₂-base material. However, even in thick deposits (coatings or preforms) composed of many splat-quenched layers, some amount of cubic phase was always present, indicating that under all conditions splat quenching generates much higher cooling rates than water quenching, as would be expected. Upon heat treatment at temperatures of at least 1200° C. for about 5 to 120 minutes, rapid decomposition of the metastable particles and splats occurred. In both cases, the net result was a uniform nanocomposite structure, consisting of about 28 vol. % α-Al₂O₃ particles in a t-ZrO₂ matrix phase as shown in FIGS. 5B and 5C.

Referring to FIGS. 7A and 7B, microstructures 82 of YZ57A (ZrO₂(3Y₂O₃)/57Al₂O) powder are shown at various stages of processing. The water quenched particles measured at about 100 μm in diameter exhibited refined eutectic structures composed of ZrO₂-rich nanofibers in an Al₂O₃-rich matrix phase. The small particles cooled at the highest rates showed the finest structures with nanofibers smaller than 30 nm diameter.

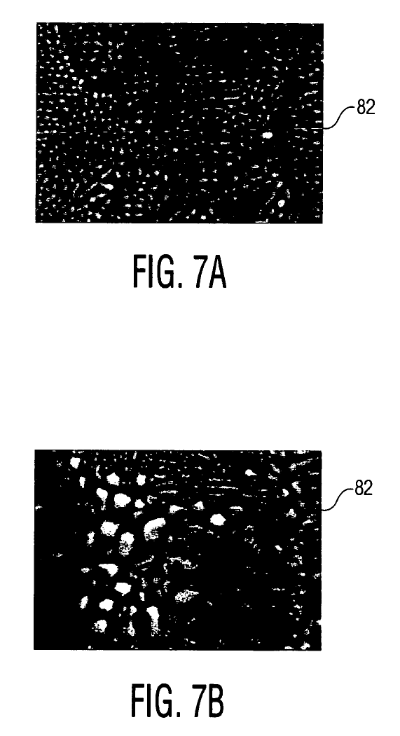

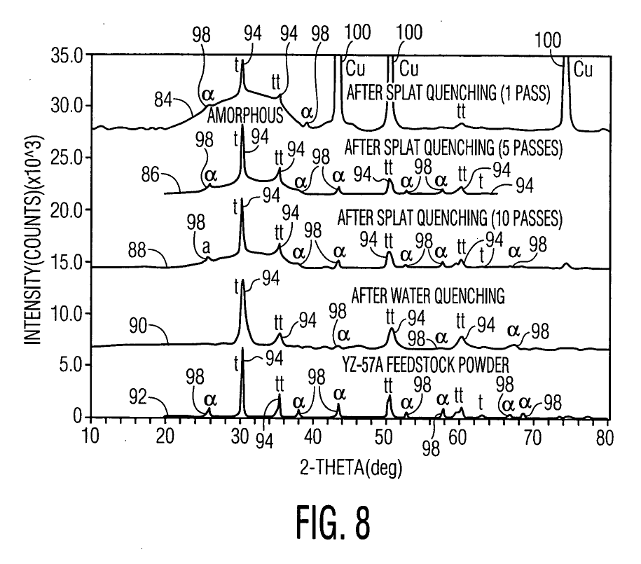

Referring to FIG. 8, a series of x-ray diffraction patterns 84, 86, 88, 90 and 92, respectively, are shown for YZ-57A powder of FIGS. 7A and 7B before and after splat quenching. The pattern 84 represents structures after one pass of splat quenching. The pattern 86 represents structures after five passes of splat quenching. The pattern 88 represents structures after ten passes of splat quenching. The pattern 90 represents structures after water quenching. The pattern 92 represents structures of the YZ-57A feedstock powder.

Peaks 94 indicate the presence of tetragonal ZrO₂, peaks 98 indicate the presence of hexagonal Al₂O₃, and peaks 100 indicate the presence of copper. The YZ-57A powder showed evidence for a significant amount of amorphous component, which decreased with increasing thickness of deposited material, again reflecting a decrease in the effective cooling rate with increasing deposit thickness.

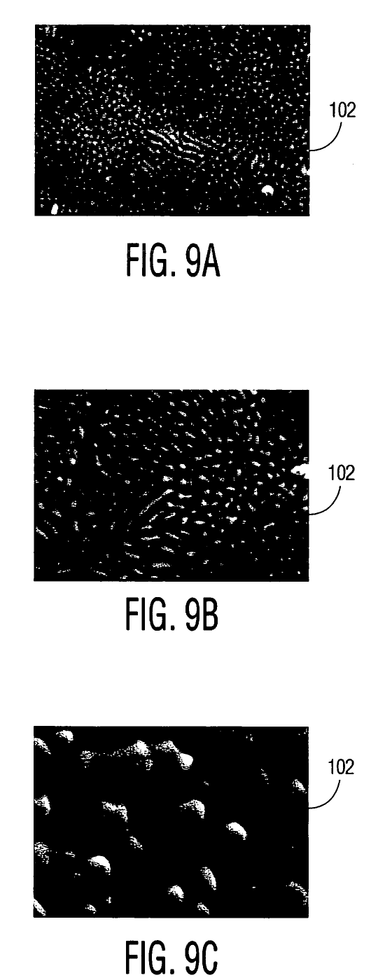

Referring to FIGS. 9A-9C, microstructures 102 of YZ57A (ZrO₂(3Y₂O₃)/57Al₂O) powder are shown at various stages of processing. Upon water quenching, the composition exhibited rod-like eutectic structure in FIG. 9A. With reference to FIG. 9B, decomposition of the melt-quenched material at temperatures of at least 1200° C. again produced a uniform nanocomposite structure of α-Al₂O₃ and t-ZrO₂, but with a higher volume fraction (about 67 vol. %) of α-Al₂O₃ than previously. An interesting feature is the retention of the nanofibrous structure, albeit somewhat coarsened in the form of spheroids, after annealing at 1200° C. for 1 hour as shown in FIG. 9B. This suggests that sintering at high temperature for short time should enable retention of some features of the original nanofibrous structure, which should enhance toughness via a crack deflection mechanism. As shown in FIG. 9C, the particles exhibited further coarsening of the duplex structure (t-ZrO₂+α-Al₂O₃).

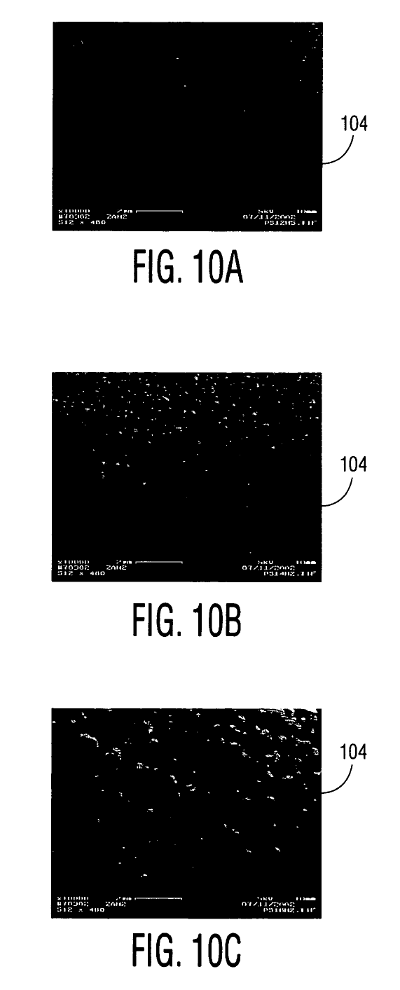

Referring to FIGS. 10A-10C, microstructures 104 of YZ27A22S (ZrO₂(3Y₂O₃)/27 Al₂O₃/22 MgAl₂O₄) powder are shown after various heat treatments. Upon heat treatment, rapid decomposition of this three-component metastable phase occurred at temperatures of about 1400° C. as shown in FIG. 10B, somewhat higher than that of the two-component systems discussed above. At 1600° C., the nanocomposite structure consisted of roughly equal volume fractions of three equilibrium phases: t-ZrO₂, α-Al₂O₃, and spinel-MgAl₂O₄ as shown in FIG. 10C.

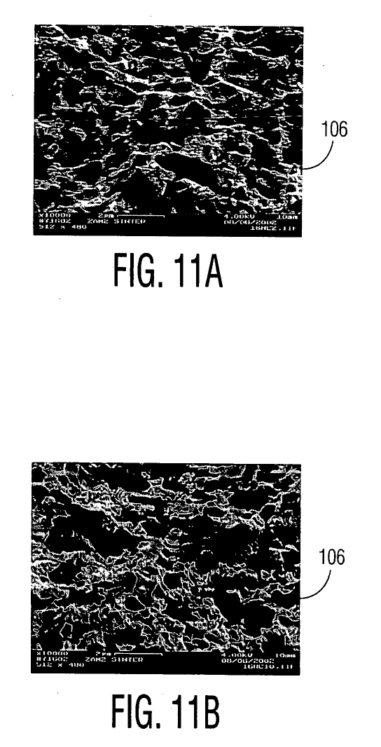

Referring to FIGS. 11A and 11B, micrographs 106 of the fracture surface of a fully dense triphasic nanocomposite ceramic material is shown after sintering at about 1600° C. for about 2 hours. When the triphasic nanocomposite ceramic was fractured, the surprising finding was the irregular appearance of the fracture surface which indicated that propagating cracks follow a tortuous path through the mixed-phase structure. This is taken to be an indication that the material has good fracture strength and toughness.

Measurements of the hardness, bend strength, and fracture toughness of these ZrO₂-base nanocomposite ceramics of the present invention were made for comparative purposes. Some preliminary machining tests have been carried out, using the YZ20A nanocomposite ceramic as a work tool material. Good cutting performance has been demonstrated, with improvements to tool life expected. Improvement to tool life can be attained by increasing the volume fraction of the ceramic phase such as α-Al₂O₃ in the nanocomposite ceramic material. It is for this reason that the YZ57A composition is currently being evaluated for this application.

Several mechanisms appear to contribute to the improved cutting performance of the YZ20A nanocomposite ceramic material. First, the presence of about 28 vol. % of very hard α-Al₂O₃ particles uniformly dispersed in a tough partially-stabilized ZrO₂ matrix phase (see Table II) enhances the hardness of the nanocomposite. Second, the presence of a crack deflection mechanism (see FIG. 2A) further enhances fracture toughness through decohesion of a multitude of α-Al₂O₃/t-ZrO₂ interfaces in the material. Third, transformation toughening by abrading the surface layers of the nanocomposite ceramic (see FIG. 3B) introduces surface compressive stresses that mitigate surface crack initiation and growth during tool wear. Fourth, the thermal mismatch between the ceramic phase, α-Al₂O₃ and the matrix phase, t-ZrO₂, generates compressive stresses particularly during the cool down period after the sintering and heat treatment process. The compressive stresses in the nanodispersed αAl₂O₃ particles at least temporarily halt or arrest crack propagation, and potentially stimulate transformation toughening in adjacent regions of the matrix phase containing partially-stabilized ZrO₂. Fifth, the poor heat transfer characteristic of the material particularly at the tool/work piece interface, due in part to the low thermal conductivity of the t-ZrO₂ matrix phase (see Table 2), ensures that most of the heat generated during cutting is carried away by the machined material, thus accommodating high machining rates.

Applicants note another important factor in the design of nanocomposite ceramics for superior toughness is modification of the morphologies of the constituent phases by stress-annealing. Stress annealing can be implemented during or after pressure-assisted sintering of the metastable powder compact. Another important technical issue is the effect of sintering temperature and time on the final scale of the nanocomposite ceramic structure. Preliminary work has indicated that pressure-assisted sintering at relatively high temperatures for short time periods can be utilized without adverse effects, since the mutual impedance to grain growth of the corresponding nanophases is strong and robust during the limited exposure time. These and other related issues are being further investigated.

In principle, there are several methods that can be used to fabricate ZrO₂-base nanocomposite ceramics of the present invention. The methods of producing the materials of the present invention will be discussed herein including methods for modifying or adjusting the mechanical performance of the materials via control of structure and processing.

The fabrication process begins with obtaining starting powders comprising ceramics selected from magnesium oxides, yttrium oxides, aluminum oxides, aluminum nitride, silicon carbide, boron nitride, silicon nitride, boron carbide, boron carbide, silicon oxide, and the like, and combinations thereof, and zirconia (ZrO₂) suitable for plasma processing. Such starting powders can be obtained from commercial sources in the form of fine-particle ceramic aggregates having average particle sizes in the range of about up to 50 microns in diameter. The starting powders are converted to nanosized metastable particles through a suitable melt-quench process such as, for example, plasma spray processing.

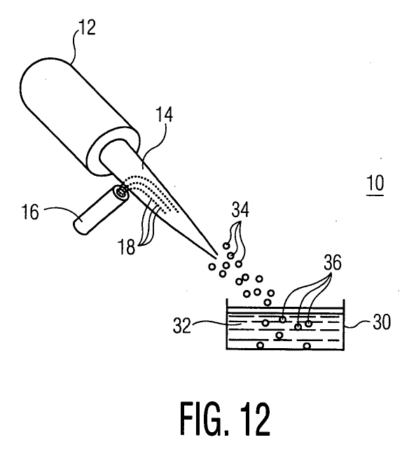

Referring to FIG. 12, a plasma spray apparatus 10 is shown to illustrate the melt-quench process using plasma spray to produce metastable ceramic particles from starting microsized ceramic powders. The plasma spray apparatus 10 includes a plasma gun 12 (e.g, an arc plasma torch) capable of producing a plasma flame 14, a powder feed 16 for supplying starting powder 18 to the flame 14, and a water bath 30 containing water 32. The powder feed 16 supplies the starting powder 18 into the plasma flame 14. The starting powder 18 is converted by the flame 14 into molten particles 34 and conveyed by the inertia of the flame 14 in the form of a spray to the water bath 30. Once in contact with the water 32, the molten particles 34 are rapidly cooled into water quenched particles 36 which are in the form of metastable particles. It is noted that not all the feed powder 16 is melted in a single pass through the plasma flame 14 since each particle may traverse different trajectories through the plasma flame 14. Accordingly, it may be necessary to subject the water quenched particles 36 to the plasma spray process at least one more pass through the apparatus 10. In this manner, a completely homogenous metastable powder composition can be produced.

In addition to water quenching, another quenching process can be used to rapidly cool and solidify the molten particles 34. Splat quenching utilizes a rotating or translating metal chilling plate (not shown) to provide a cooling substrate. This process is capable of producing higher cooling rates compared to water-quenching. The previously water-quenched powder can be re-passed through the plasma flame 14 for spraying onto a rotating or translating metal chilling plate (not shown). A continuously varying cooling rate can be achieved by repeatedly passing the chilling plate through the plasma flame 14 to build up one or more superimposed splat quenched layers. After generating about 10 splat quenched layers, the cooling rate, and thus the corresponding metastable structure remained substantially the same with each pass.

In order to ensure complete particle melting and homogenization during the melt process, and enhance the efficiency of the melt-quench process, an inductively-coupled or RF plasma torch (not shown) comprising an axial powder feed system can be used for maintaining longer average particle residence time to ensure thorough melting in a single pass through the plasma flame. Although the plasma melt-quenching process is described above as a suitable means to generate metastable ceramic powder, it will be recognized by those skilled-in-the-art that other known rapid solidification processing methods can be used for realizing the same purpose. One example is the method used today in the production of ceramic grinding media. A skull-melted ceramic is cast between massive metal chill plates to obtain a rapidly solidified ceramic product. The grinding media is obtained by crushing the melt-quenched pieces in a succession of milling operations. Currently, a chill-casting process is performed at moderate cooling rates, since a relatively large gap of about 0.3 cm between the chill plates limits the cooling rate. However, it can be adapted to produce melt-quenched material that experiences much higher cooling rates. When this material becomes available, we will evaluate its potential as a starting material for fabricating nanocomposite ceramics of the present invention. Applicants will also investigate the sinterability of metastable ceramic nanoparticles, produced by plasma processing of liquid precursor feeds as described in U.S. Pat. Nos. 6,025,034, and 6,277,448, the contents of which are incorporated herein by reference.

The produced metastable ceramic particles thereafter undergo pressure-assisted sintering to yield a nanocrystalline (single phase) or nanocomposite (multiphase) product. The pressure-assisted sintering step of the present invention can be applied to nanocomposite ceramics composed of any ceramic compositions including, but not limited to, ZrO2, Al₂O₃—, Y₂O₃—, SiO₂-base and the like, and combinations thereof. Two methods have been developed for consolidating nanosized metastable ceramic particles of these different compositions. A first method relates to intermediate temperature sintering for implementation over a relatively long processing time period of about 5 to 120 minutes at temperatures of about 1000 to 1400° C., and high temperature sintering for implementation over a relatively short processing time period of from about 0.1 to 5 minutes at temperatures up to about 1800° C. In general, high temperature/short time sintering is preferred, because it shortens the sintering cycle and reduces processing cost, while retaining a desirable nanocomposite structure.

In a typical hot pressing operation, the heat-up rate is adjusted to properly degas the porous compact, and then the temperature is rapidly increased to the final sintering temperature, while the pressure is maintained. The peak temperature may be set at as high as about 1800° C. to achieve rapid sintering in a short time, preferably from about 0.1 to 5 minutes, even the briefest excursion at the peak temperature can suffice. After densification, the material is cooled rapidly to about 1200° C. to avoid further grain coarsening, and then more slowly to ambient temperature to avoid cracking by thermal shock. This method has been successfully applied to selected ZrO₂-base systems with effective control of the final NCC structures. This method can be readily applied to other oxide ceramic materials, and particularly to multiphasic materials.

An important new insight gained from this work is recognition of the role of superplastic flow in promoting rapid sintering at high temperature. When phase decomposition commences, nanocomposite structure experiences superplasticity during formation. This facilitates the rapid compacting and sintering of the particles into a fully dense material. The superplastic flow enhanced sintering can be used to fabricate near net shape articles of manufacture composed of a densified nanocomposite ceramic.

Applicants note that the plasma melt-quenching process can also be used to make metastable structures in the form of thick coatings or preforms, simply by directing a continuous stream of molten particles onto a chilled rotating or translating substrate as described above. In this manner, it is preferred to use double melt-quenched powder as the feed material to ensure that the deposited material is metastable throughout, even when a high powder feed rate is used for efficient deposition.

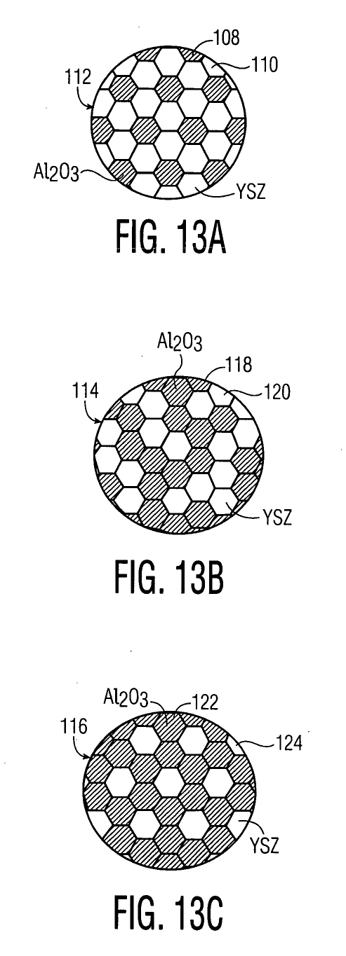

An important feature of this invention is that the hardness of a ZrO₂-base nanocomposite ceramic can be enhanced while significantly maintaining toughness. This can be achieved by increasing the volume fraction of one or more its constituent hard ceramic phases, such as, for example, Al₂O₃, MgAl₂O₄ and ZrSiO₄. This effect is illustrated in FIGS. 13A to 13C. Referring to FIG. 13A, a nanocomposite material structure 112 comprising 20 vol % Al₂O₃ in the form of a uniform dispersion of α-Al₂O₃ nanoparticles 108 in a continuous nanocrystalline yttria stabilized zirconia (t-YSZ) matrix phase 100 (particle dispersed nanocomposite ceramic) is shown schematically. Referring to FIG. 13B, a nanocomposite material 114 comprising 50 vol % Al₂O₃ in the form of a continuous nanocrystalline α-Al₂O₃ matrix phase 118 and a continuous nanocrystalline t-YSZ matrix phase 120 (bicontinuous nanocomposite ceramic) is shown schematically. Referring to FIG. 13C, a nanocomposite material structure 116 comprising 80 vol % Al₂O₃ in the form of a uniform dispersion of yttria stabilized zirconia (t-YSZ) nanoparticles 124 in a continuous nanocrystalline α-Al₂O₃ matrix phase 122 (particle dispersed nanocomposite ceramic).

As indicated, the hardness increases from the structure 112 of FIG. 13A to the structure 114 of FIG. 13B with increase of volume fraction of Al₂O₃ up to about 50 vol. %, where a bicontinuous structure is formed as specifically shown in FIG. 13B. Beyond this point, the NCC structure is reversed as compared between the structure 112 of FIG. 13A and the structure of 116 of FIG. 13C. The hardness continues to increase from the transition of the structure 114 of FIG. 13B to the structure 116 of FIG. 13C with increasing volume fraction of Al₂O₃. However toughness decreases significantly in the structure 116 of FIG. 13C, where Al₂O₃ is now the continuous matrix phase, as compared to the structure 114 of FIG. 13B.

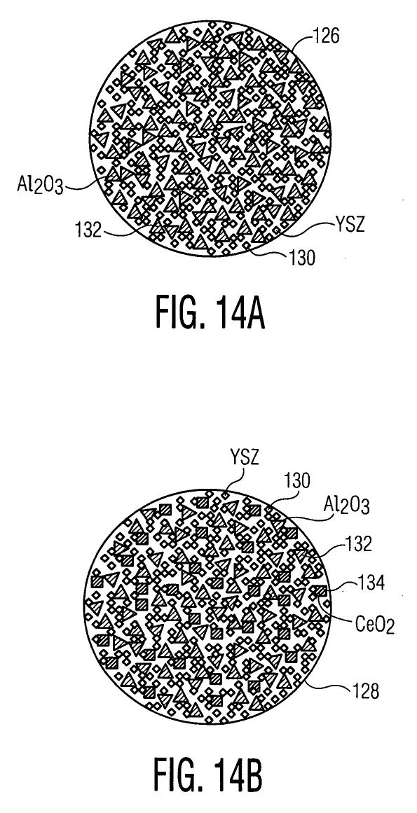

One way to overcome this limitation in the amount of α-Al₂O₃ that can be incorporated in a tough PSZ matrix phase is to develop multi-modal structures 126 and 128 as shown schematically in FIGS. 14A and 14B, respectively, in which a tough PSZ matrix phase 130 is used to bind together fine-particle aggregates of one or more dispersed ceramic phases. Specifically in FIG. 14A, the multi-modal structure 126 includes Al₂O₃ fine particle aggregates 132 forming the disperse ceramic phase along with the tough PSZ matrix phase 130. Specifically in FIG. 14B, the multi-modal structure 128 includes Al₂O₃ fine particle aggregates 132 and CeO2 fine particle aggregates 134 forming the disperse ceramic phases along with the tough PSZ matrix phase 130.

Note that multi-modal is defined as a blend of two or more ceramic particles of different size, which may or may not have different shapes. In some cutting tool applications, such as those involving interrupted cuts, a ZrO₂-rich NCC as shown in FIG. 13A is preferred because of its superior fracture toughness.

In other cutting tool applications, where hardness is the overriding consideration, then a multi-modal Al₂O₃-rich NCC as shown in FIGS. 14A and 14B is preferred. In general, the best cutting performance is achieved when the cutting edge of the tool is functionally graded such that the wear surface is composed of a very hard Al₂O₃-rich layer and the backing or support material is a tough ZrO₂-rich material.

In summary, the NCC systems of interest here are those in which an appreciable volume fraction of tough partially-stabilized ZrO₂ (3-15 MPa. m^{1/2}) is combined with one or more hard ceramic phases, including Al₂O₃ (19-26 GPa), MgAl₂O₄ (14-18 GPa), 3Al₂O₃.2SiO₂ (15 GPa), Y₃Al₅O₁₂ (18 GPa), and ZrSiO₄ (˜15.0 GPa) phases.

Although various embodiments of the invention have been shown and described, they are not meant to be limiting. Those of skill in the art may recognize various modifications to these embodiments, which modifications are meant to be covered by the spirit and scope of the appended claims. For example, rather than Zirconia-based matrix nanocomposites, it is clear that other ceramics such as Al₂O₃ (alumina oxide), TiO₂ (titanium oxide), Y₂O₃ (yttrium Oxide), MgO (Magnesium Oxide), Mg—Al—O (spinel) and so forth can be used as the matrix phase. Also, the present invention is not limited to oxide nanoceramics, but may also include non-oxide ceramic systems such as SiC (silicon carbide), SiNₓ (silicon nitride), B₄C (boron carbide), TiC (titanium carbide), TiN (titanium nitride), and so forth.

What is claimed is:

1. A nanocomposite ceramic composition, comprising a uniform dispersion of nanosize ceramic particles composed of at least one ceramic phase, interspersed and bound throughout with a tough zirconia matrix phase.

2. The nanocomposite ceramic composition of claim 1, wherein the ceramic phase is selected from the group consisting of magnesium oxide, yttrium oxide, aluminum oxide, aluminum nitride, silicon carbide, boron nitride, silicon nitride, boron carbide, silicon oxide, magnesium aluminate spinel, titanium carbide, titanium nitride, zirconium silicon oxide, and combinations thereof.

3. The nanocomposite ceramic composition of claim 1, wherein the tough zirconia matrix phase is partially stabilized zirconia (PSZ).

4. The nanocomposite ceramic composition of claim 1, wherein the nanosize ceramic particles are present in an amount of up to 80 volume percent based on the total volume of the composition.

5. The nanocomposite ceramic composition of claim 1, wherein the dispersion has a multi-modal structure.

6. The nanocomposite ceramic composition of claim 1, wherein the dispersion has a nanofibrous structure.

7. The nanocomposite ceramic composition of claim 1, wherein all of the ceramic phases of the sintered composite comprise an average grain size of up to 500 nm.

8. The nanocomposite ceramic composition of claim 1, wherein all of the ceramic phases of the sintered composite comprise an average grain size of up to 50 nm.

9. The nanocomposite ceramic composition of claim 1, wherein the ceramic phase of the sintered composite comprises an average fiber diameter size of up to 500 nm.

10. The nanocomposite ceramic composition of claim 1, wherein the ceramic phase of the sintered composite comprises an average fiber diameter size of up to 50 nm.

11. A method for making a nanocomposite ceramic composition, comprising the steps of:
rapidly solidifying molten particles of at least one ceramic phase and a zirconia matrix phase to yield micron size metastable particles; and
consolidating the micron size metastable particles to yield a uniform dispersion of nanosize particles of the at least one ceramic phase interspersed and bound with the zirconia matrix phase.

12. The method of claim 11, wherein the ceramic phase is selected from the group consisting of magnesium oxide, yttrium oxide, aluminum oxide, aluminum nitride, silicon carbide, boron nitride, silicon nitride, boron carbide, silicon oxide, magnesium aluminate spinel, titanium carbide, titanium nitride, zirconium silicon oxide, and combinations thereof.

13. The method of claim 11, wherein the matrix phase is partially stabilized zirconia.

14. The method of claim 11, wherein the rapidly solidifying step further comprises the step of spraying the molten particles on a sufficiently cooled substrate.

15. The method of claim 11, further comprising the step of melting the particles of the ceramic phase and of the matrix phase.

16. The method of claim 11, wherein the melting step is carried out through a plasma flame.

17. The method of claim 16, wherein the plasma flame is generated by a device selected from the group consisting of an arc-plasma torch and an inductively-coupled or RF plasma torch.

18. The method of claim 15, wherein the melting step is carried out through a skull melt process.

19. The method of claim 11, wherein the rapidly solidifying step is carried by a process selected from the group consisting of melt spinning, melt extraction, and quenching between twin rollers.

20. The method of claim 11, wherein the consolidating step comprises compressing the nanosized metastable particles at a sufficient pressure for about 0.1 to 120 minutes.

21. The method of claim 20, wherein the pressure is in the range of up to 1.5 GPa.

22. The method of claim 12, wherein the consolidating step comprises heating the nanosized metastable particles at a sufficient temperature for about 0.1 to 120 minutes, at pressures of up to 0.1 GPa.

23. The method of claim 22, wherein the temperature ranges from about 1000° C. to 1800° C., at pressures of up to 0.1 GPa.

24. A method for making a nanocomposite ceramic composition, comprising the steps of:
rapidly solidifying molten particles of at least one ceramic phase and another matrix phase chosen from magnesium oxide, yttrium oxide, aluminum oxide, aluminum nitride, silicon carbide, boron nitride, silicon nitride, boron carbide, silicon oxide, magnesium aluminate spinel, titanium carbide, titanium nitride, zirconium silicon oxide, and combinations thereof to yield micron size metastable particles; and
consolidating the micron size metastable particles to yield a uniform dispersion of nanosize particles of the at least one ceramic phase interspersed and bound with the matrix phase.

25. The method of claim 24, wherein the ceramic phase is selected from the group consisting of magnesium oxide, yttrium oxide, aluminum oxide, aluminum nitride, silicon carbide, boron nitride, silicon nitride, boron carbide, boron carbide, silicon oxide, and combinations thereof.
